(19) United States
(12) Patent Application Publication
(10) Pub. No.: US 2006/0158475 A1
(43) Pub. Date: Jul. 20, 2006

(54) Printer calibration

(76) Inventors: Dan Arquilevich, Portland, OR (US); Christopher Fox, Vancouver, WA (US); Ching Keong Tham, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/038,661

(22) Filed: Jan. 19, 2005

(51) Int. Cl. B41J 29/393

(52) U.S. Cl. 347/19

(57) ABSTRACT

A printer calibration method includes printing a first pattern having a first field and a first overlay formed within the first field. A second pattern is printed having a second field and a second overlay formed within the first field. A calibration parameter is updated based on a selection of the first or second test pattern.

An ink printer employs one or more pens to place ink onto a sheet of paper or other type of sheet. Multiple pens can be fixed in an array spanning a width of the media sheet. Alternatively one or more pens may be mounted on a carriage, which is arranged to scan back and forth across a width of the media sheet. A given pen includes an array of nozzles that eject individual drops of ink. The drops collectively form a band or “swath” of an image, such as a picture, chart, or text. As the media sheet is advanced, an image is incrementally printed.

Print quality can benefit from periodically updating one or more calibration parameters. These parameters can affect the manner in which a media sheet is advanced during printing. The parameters can be used to help align pens with one another and to help maintain bidirectional printing alignment when a carriage is used to scan a pen back and forth across a page.

### DESCRIPTION OF THE DRAWINGS

FIG. 1 is a perspective view of an exemplary pen.

FIGS. 2-4 illustrate exemplary calibration pattern sets according to various embodiments of the present invention.

FIG. 5 is a block diagram of an exemplary image forming device in which various embodiments of the present invention may be implemented.

FIG. 6-9 are schematic illustrations of a sheet of a media sheet being advanced past a pen carriage according to various embodiments of the present invention.

FIG. 10 is a block diagram illustrating logical elements of a controller according to an embodiment of the present invention.

FIGS. 11 is an exemplary flow diagram illustrating steps taken to implement an embodiment of the present invention.

FIGS. 12 and 13 are schematic illustrations showing bidirectional printing of calibration patterns according to an embodiment of the present invention.

FIGS. 14 and 15 are schematic illustrations showing selective nozzle printing of calibration patterns according to an embodiment of the present invention.

FIGS. 16-19 are schematic illustrations showing selective nozzle printing of a first calibration pattern set and a fractional step calibration pattern set according to an embodiment of the present invention.

### DETAILED DESCRIPTION OF THE INVENTION

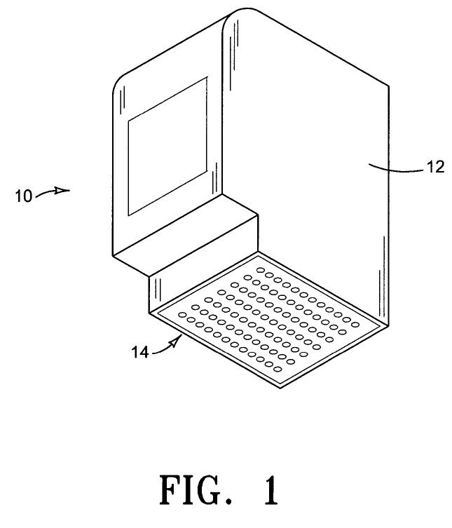

INTRODUCTION: A typical ink printer advances a media sheet past a carriage scanning one or more pens back and forth across the sheet. The pens are instructed to eject ink onto the sheet forming a desired image. FIG. 1 illustrates an exemplary pen 10 utilized by printers and other image forming devices. Pen 10 that includes a reservoir 12 supplying ink to nozzles 14. Nozzles 14 are each responsible for ejecting ink from reservoir 12. An image forming device may employ any suitable number of such pens. Calibrating the mechanisms that feed the media sheet, move the carriage, and cause the pens to eject ink can improve the printer's performance.

The following description is broken into sections. The first section, labeled “Patterns” describes three exemplary calibration patterns that can be used to calibrate an image forming device. The second section labeled “Components,” describes an example of the physical and logical components that can be used to calibrate an image forming device. The third section, labeled “Operation,” describes an exemplary series of method steps for calibrating an image forming device and various methods for generating calibration patterns.

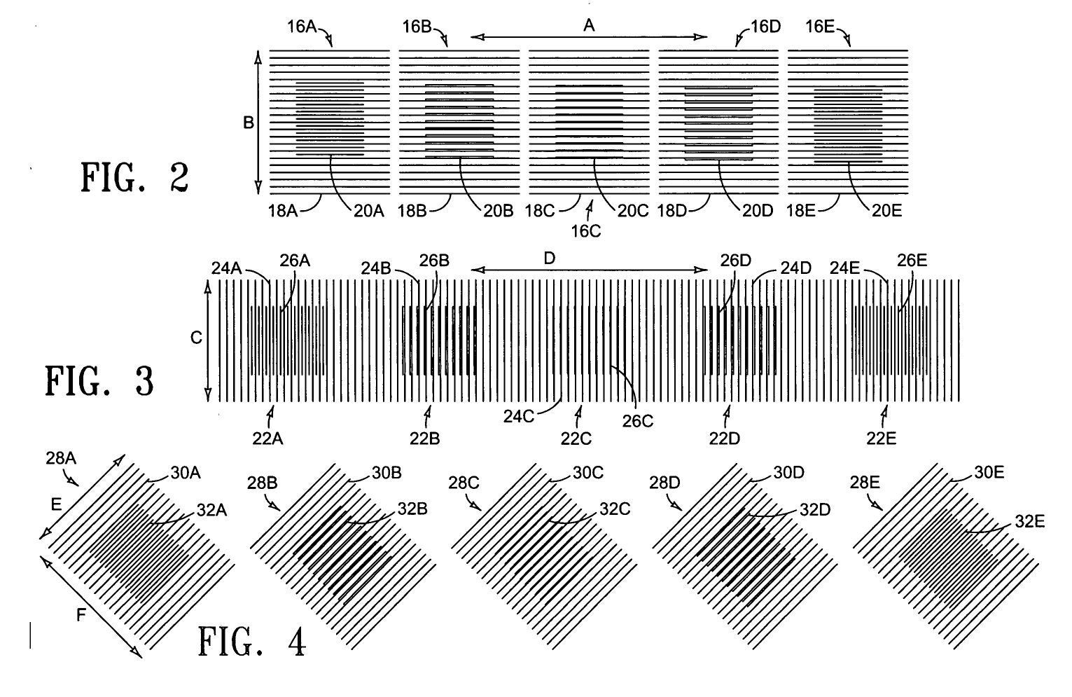

PATTERNS: FIGS. 2-4 illustrates exemplary calibration pattern sets. Starting with FIG. 2, calibration pattern set 16 includes calibration patterns 16A-16E. Each calibration pattern includes a field 18 and an overlay 20. For example, calibration pattern 16A includes field 18A and overlay 20A. Calibration pattern 16E includes field 18E and overlay 20E. Each field 18A-18E is made up a series of evenly spaced and parallel horizontal lines referred to as field lines. In this example, the field lines are all parallel to axis A. Each overlay 20A-20E is made up of a series of evenly spaced lines, referred to as overlay lines, formed within a corresponding field 18A-18E.

A shown, the overlay lines are also parallel to axis A. For each successive pattern 16B-1 6E, the position of that pattern's respective overlay 20B-20E is incremented along an axis B relative to the position of the prior pattern's overlay 20A-20D. In other words, the overlay 20B-20E for each successive pattern 16B-16E is incrementally shifted along axis B. Axis B is perpendicular to axis A. To achieve the same effect, the field 18B-18E for each successive pattern 16B-16E could instead be incrementally shifted along axis B.

The field lines and the overlay lines share common attributes in that they are parallel with one another and have the same uniform spacing. Depending on the particular calibration, field lines and overlay lines are formed in different manners. For example, field lines may be formed using one pen and the overlay lines with another pen. Using a single pen, field lines may be formed using one set of nozzles and overlay lines formed using another set. Field lines may be formed when a pen is scanned across a page in one direction and the overlay lines formed when the pen is scanned in the opposite direction. Examples of each of these are discussed below.

When forming calibration pattern 16, an image forming device, based on its current calibration parameters, will attempt to form one of the calibration patterns 16A-16E so that the pattern's overlay lines and field lines are superimposed. The other calibration patterns are formed based on incrementally adjusted calibration parameters. This creates the effect of varying the apparent overlap between the field lines and the overlay lines between successive calibration patterns 16A-16E.

The best aligned calibration pattern 16A-16E is a pattern in which the overlay lines are least visible against the background of the field lines. That calibration pattern is then selected and the image forming device can be calibrated according to the particular calibration parameters used to form the selected calibration pattern. In FIG. 2, calibration pattern 16C would be selected. Assuming calibration pattern 16C was formed using current calibration parameters, no calibration would be needed. However, if calibration pattern 16C was formed using adjusted calibration parameters, the image forming device would be calibrated based on the adjusted parameters.

Calibration patterns 16A-16E can be optically scanned to identify the best aligned pattern. Each pattern 16A-16E can be scanned to measure a level of optical contrast between the overlay lines and the surrounding field lines in near proximity. The measured values can be compared, and the pattern 16A-1 6E with the lowest contrast reading will be selected as the best aligned.

FIGS. 3 and 4 illustrate possible variations in the orientation of field lines and overlay lines. In FIG. 3, calibration patterns 22A-22E include fields 24A-24E and overlays 26A-26E. The field lines of fields 24A-24E are evenly spaced and parallel to vertical axis C. Formed within fields 24A-24E, the overlay lines of overlays 26A-26E are also evenly spaced and parallel to vertical axis D. For each successive pattern 22B-22E, the position of that pattern's overlay 26B-26E is incremented along a horizontal axis D relative to the position of the prior pattern's overlay 26A-26D. In other words, the overlay 26B-26E for each pattern 22B-22E is incrementally shifted along axis D. Axis D is perpendicular to axis C. To achieve the same effect, the field 24B-24E for each pattern 22B-22E could instead be incrementally shifted along axis D.

In FIG. 4, calibration patterns 28A-28E include fields 30A-30E and overlays 32A-32E. The field lines of fields 30A-30E are evenly spaced and parallel to tilted axis E. Formed within fields 30A-30E, the overlay lines of overlays 32A-32E are also evenly spaced and parallel to tilted axis E. For each successive pattern 28B-28E, the position of that pattern's overlay 26B-26E is incremented along a tilted axis F relative the position of the prior pattern's overlay 32A-32D. In other words, the overlay 32B-32E for each pattern 29B-28E is incrementally shifted along axis F. Axis F is perpendicular to axis E. To achieve the same effect, the field 30B-30E for each pattern 28B-28E could instead be incrementally shifted along axis F.

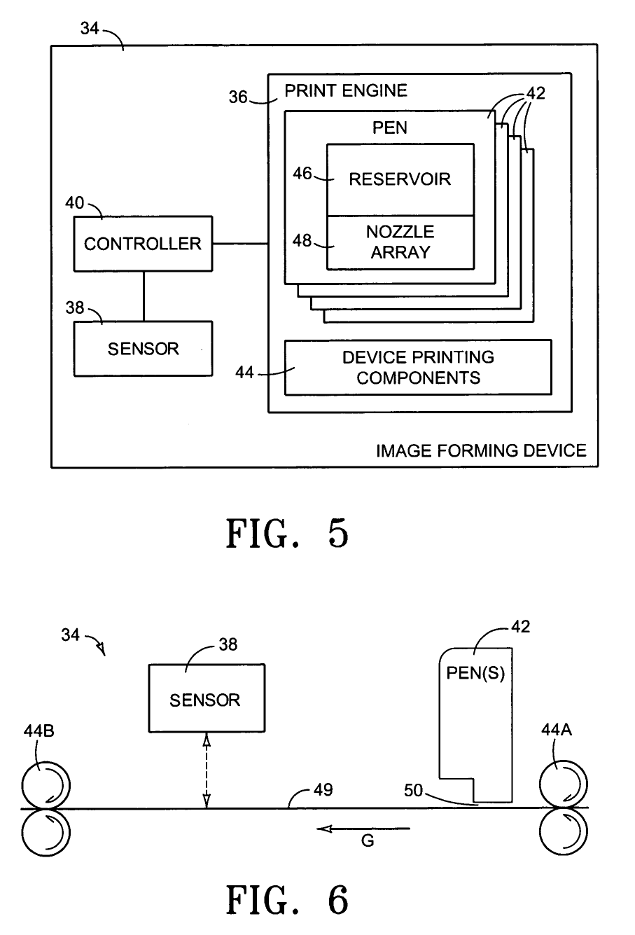

COMPONENTS: FIG. 5 illustrates an exemplary image forming device 34 in which various embodiments of the present invention may be implemented. Image forming device 34 represents a device capable of forming a desired image on a print medium such as paper. Image forming device 34 includes print engine 36, sensor 38, controller 40. Print engine 36 represents generally the hardware components capable of forming an image on a media sheet. Sensor 38 represents generally any device capable of being utilized to measure optical contrast levels between the overlay lines and field lines of a calibration pattern. Controller 40 represents the hardware and programming responsible for directing the operation of print engine 36 and sensor 38.

Print engine 36 is shown to include pens 42 and device printing components 44. Each pen 42 includes reservoir 46 and nozzle array 48. While print engine 36 is shown to include four pens 42, print engine 36 may include a single pen 42 or any other number of pens 42. In operation, nozzle array 48 is caused to selectively eject ink from reservoir 46 according to a desired print image. Device printing components 44 advance a media sheet along a media path that passes through a print zone underneath nozzle array 48 of each pen 42. As the media sheet advances through the print zone, one or more of the pens 42 forms a series of individual drops of ink on the media sheet. Once the media sheet has passed through and out of the print zone, the series of drops disposed on the media collectively form an image, such as a picture, chart, or text.

FIG. 6-9 are partial schematic views of image forming device 34 shown in FIG. 5, according to various exemplary embodiments. FIG. 6 is a side view that illustrates an example of the relative positioning of pens 42 and sensor 38. Here, device printing components 44 (FIG. 5) include pinch rollers 44A and 44B that, when rotated, advance media sheet 49 along a media path G through print zone 50 and past sensor 38. While not shown, a stepper motor may be utilized to rotate pinch rollers 44A and 44B to accurately position media sheet 49. Sensor 38 is positioned downstream from pen 34 so that it can scan calibration patterns formed on media sheet 49.

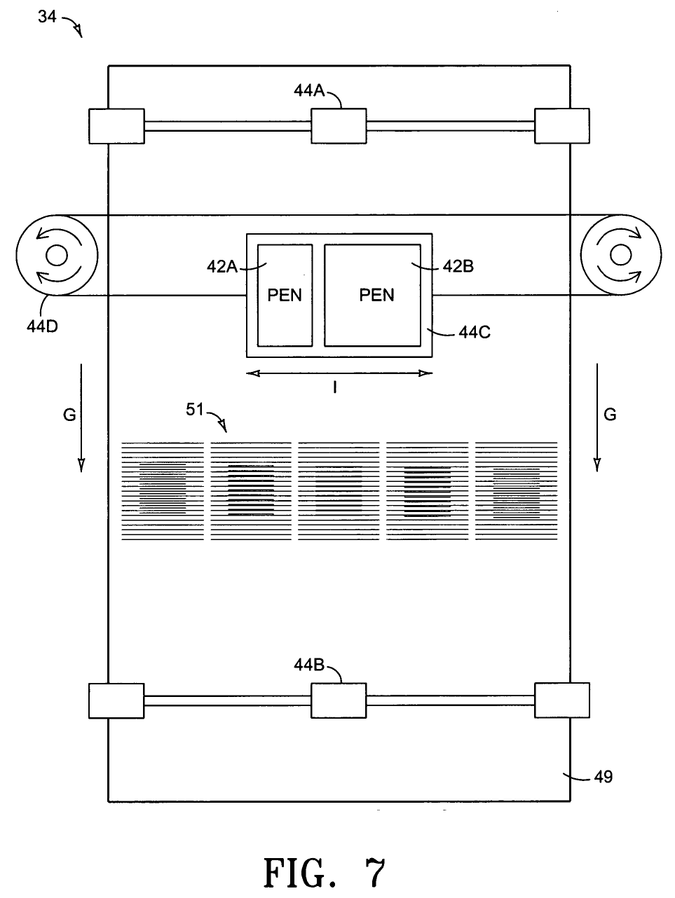

FIG. 7 is a top view in which device printing components 44 (FIG. 5) include pinch rollers 42A, 42B, carriage 44C, and carriage drive 44D. Carriage 44C represents generally any structure capable of holding pens 42A and 42B. Carriage drive 44D represents generally any mechanism suitable for scanning carriage 44C back and forth across media sheet 49 along axis I as pinch rollers 44A and 44B advance media sheet 49 along media path G. While not shown, carriage drive 44D may include a stepper motor that can be used to rotate carriage drive 44D to accurately position carriage 44C over media sheet 49.

In the example shown, one or both of pens 42A and 42B have been used to form calibration pattern set 51. Here, image forming device 34 does not include a sensor such as sensor 38 in FIGS. 5 and 6. Instead a user will visually examine calibration pattern set 51 and select best aligned calibration pattern. Through a user interface supplied by driver for image forming device 34 or some other software application, the user can then inform mage forming device 34 of the section.

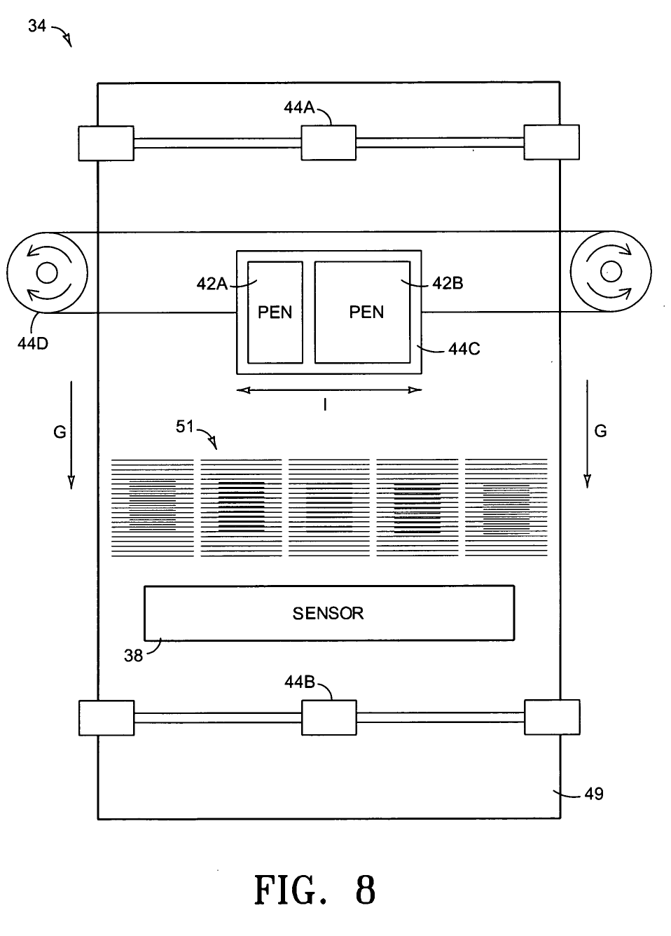

FIG. 8 is a top view that includes a sensor 38 held stationary downstream from pens 42A and 42B along print path G. In the example shown, one or both of pens 42A and 42B have been used to form calibration pattern set 51 on media sheet 49. Pinch rollers 44A and 44B advance media sheet 49 along media path G causing calibration pattern to pass under sensor 38 which is used to measure the optical contrast level of each of calibration pattern. Image forming device 34 can then compare the measured levels and select the best aligned calibration pattern.

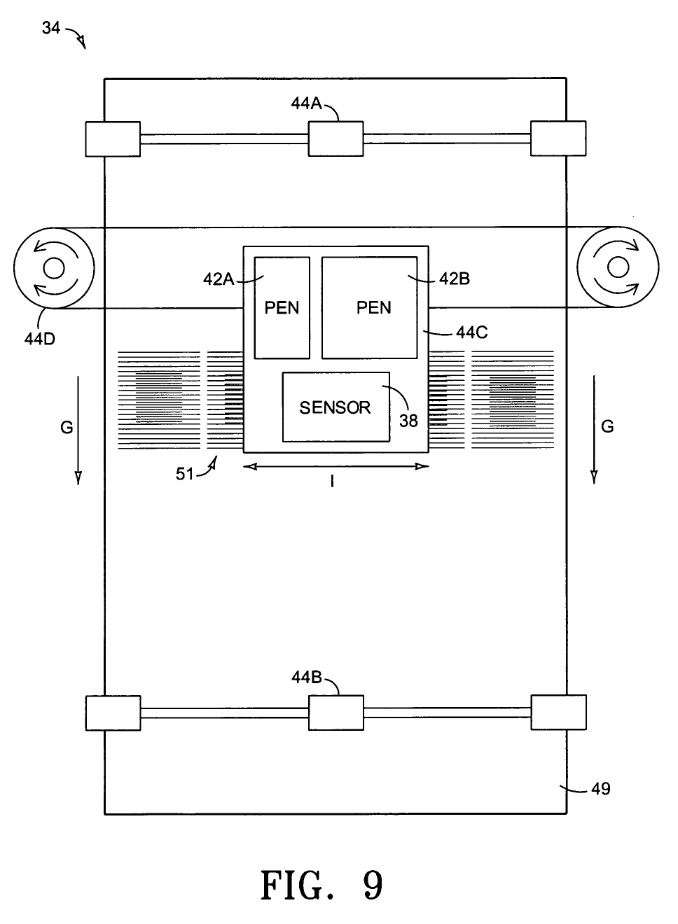

FIG. 9 is a top view that includes a sensor 38 held by carriage 44C. In the example shown, carriage 44C is scanned back and forth along axis I allowing one or both of pens 42A and 42B to form calibration pattern set 51 on media sheet 49. Pinch rollers 44A and 44B advance media sheet 49 along media path G. Carriage 44C is again scanned across media sheet 49 over calibration pattern set 51 allowing sensor 38 to be used to measure the optical contrast level of each of calibration pattern. Image forming device 34 can then compare the measured levels and select the best aligned calibration pattern.

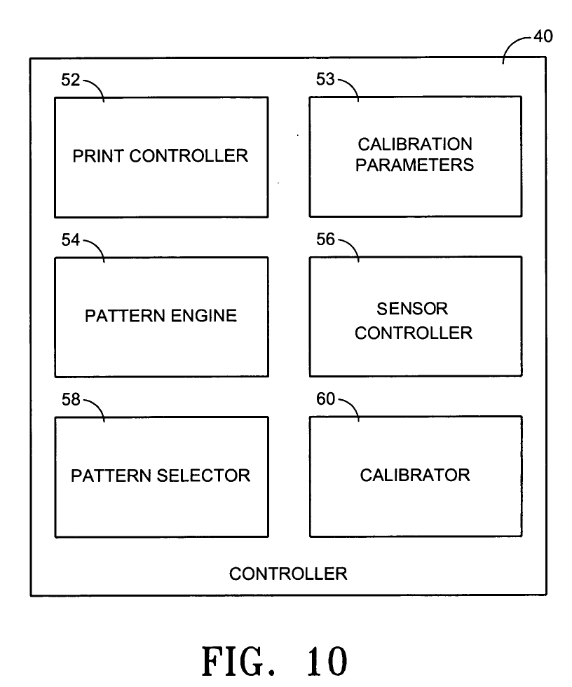

FIG. 10 is a block diagram illustrating an example of the physical and logical components of controller 40 of FIG. 5. As shown, controller 40 includes print controller 52, calibration parameters 53, pattern engine 54, sensor controller 56, pattern selector 58, and calibrator 60. Print controller 52 represents generally any combination of hardware and/or programming capable of directing print engine 36 (FIG. 5) to form a desired image on a media sheet.

Calibration parameters 53 represent data used by print controller 52 to guide the operation of the various components of print engine 36 (FIG. 5). Referring back to FIGS. 5-9, for example, certain calibration parameters help precisely time when specific nozzles 46 of a particular pen 42 are to eject ink. Other calibration parameters help guide feed rollers 44A and 44B to precisely position media sheet 49 in print zone 50 (FIG. 6).

Pattern engine 54 represents generally any combination of hardware and/or programming capable of generating and providing print controller 52 with a digital representation of a calibration pattern set such as one of the calibration patterns sets illustrated in FIGS. 24. Print controller 52 can then cause print engine 36 (FIG. 5) to form the calibration pattern on a media sheet.

Sensor controller 56 represents generally any hardware and/or programming capable of directing sensor 38 (FIGS. 5, 6, 8, and 9) to scan a calibration pattern and to measure and record optical contrast levels for each calibration pattern in the set. Pattern selector 58 represents generally any hardware and/or programming capable of comparing the measured and recorded optical contrast levels and selecting a calibration pattern based on the comparison. For example, pattern selector may identify and select a calibration pattern having the lowest measured optical contrast level.

Calibrator 60 represents any hardware and/or programming capable of updating calibration parameters 53 based on a calibration pattern selected by pattern selector 58 or as indicated by user input through a user interface. As noted above, one calibration pattern in a set may be formed according to current calibration parameters 53 with an expectation that the overlay for that calibration pattern will be aligned with the field. The other calibration patterns in the set are formed according to incrementally adjusted calibration parameters. That is, the position of the field or the overlay in each is incrementally shifted creating an expectation of varying degrees of overlap between the field and the overlay for each of the other calibration patterns.

If the image forming device is properly calibrated, the particular calibration pattern formed according to the current calibration parameters 53 should be selected. In such a case, calibrator 60 would not make any adjustments to calibration parameters 53. If the image forming device is not properly calibrated, one of the other calibration patterns formed according to adjusted calibration parameters should be selected. Calibrator 60 then updates calibration parameters 53 according to the adjusted calibration parameters used to form the selected calibration pattern.

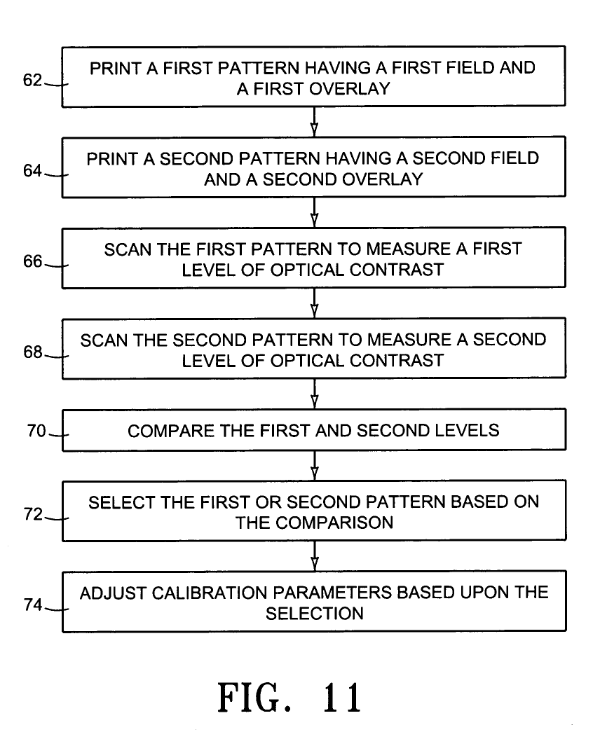

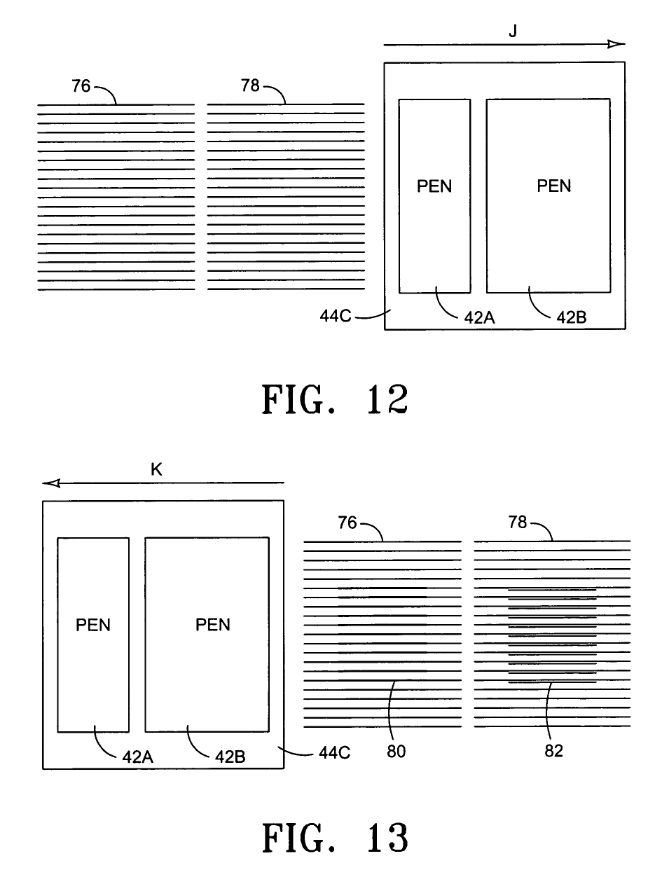

OPERATION: The operation of embodiments of the present invention will now be described with reference to FIGS. 11-19. FIG. 11 is an exemplary flow diagram illustrating steps taken to implement an embodiment of the present invention. FIGS. 12-19 are schematic illustrations showing varying methods for forming calibration patterns according to embodiments of the present invention.

Starting with FIG. 11, a first calibration pattern having a first field and a first overlay is printed (step 62). A second calibration pattern having a second field and a second overlay is printed (step 64). Referring back to FIGS. 24, each field includes a series of evenly spaced and parallel field lines, and each overlay includes a series of overlay lines parallel to the field lines. In step 64, the position of either the field lines or the overlay lines is incremented along an axis perpendicular to the field lines.

The first calibration pattern is scanned to measure a first level of optical contrast between the first overlay and the first field (step 66). The second calibration pattern is scanned to measure a second level of optical contrast between the second overlay and the second field (step 68). The first and second levels measured in steps 66 and 68 are compared (step 70). The first or second calibration pattern is selected based on the comparison (step 72). As described above, the calibration pattern associated with the lowest level of optical contrast is the best aligned calibration pattern and should be selected. Calibration parameters are adjusted based upon the selection made in step 72 (step 74).

FIGS. 12 and 13 are schematic diagrams illustrating bidirectional printing of calibration patterns using one or more pens 42A and 42B. In FIG. 12, carriage 44C is moved from left to right in direction J allowing one or both of pens 42A and 42B to form fields 76 and 78. In FIG. 13, carriage 44C is moved from right to left in direction K allowing one or both of pens 42A and 42B to form overlays 76 and 78. As is apparent, the position of overlay 82 is incremented downward relative to the position of overlay 80. A single pen 42A or 42B may be used to form fields 76 and 78 and overlays 80 and 82. Alternatively, one pen 42A or 42B may be used to form fields 76 and 78 and the other pen 42B or 42A may be used to form overlays 80 and 82.

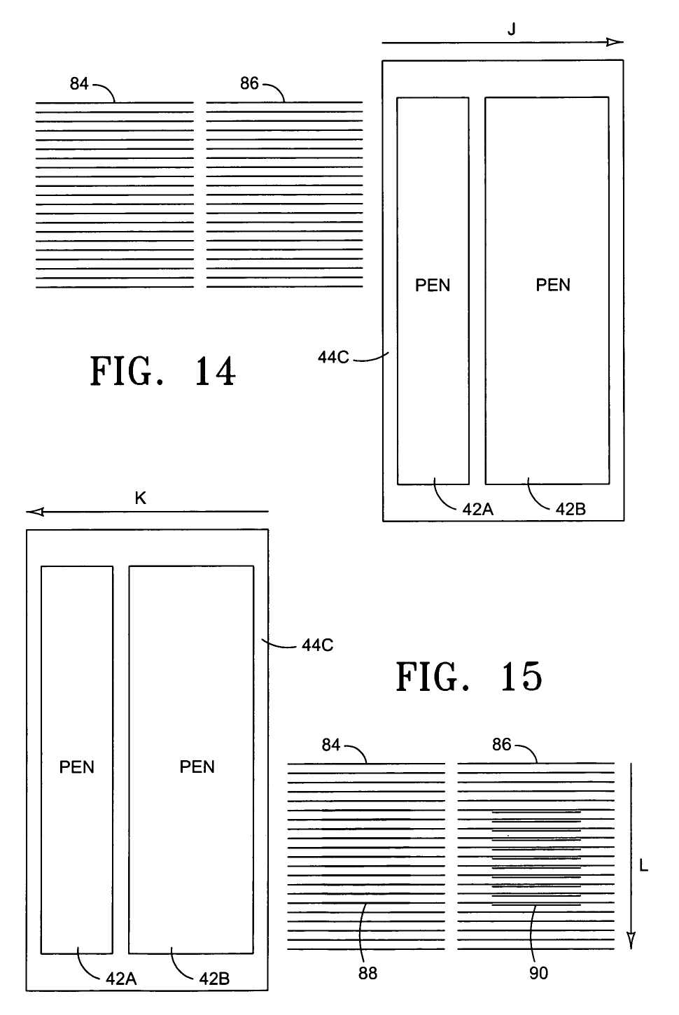

FIGS. 14 and 15 are schematic diagrams illustrating the selective use of nozzles of one or more pens 42A and 42B to print calibration patterns. In FIG. 14, carriage 44C is moved from left to right in direction J allowing a first set of nozzles of one or both of pens 42A and 42B to form fields 84 and 86. In FIG. 15, the media sheet on which fields 84 and 86 are formed is advanced a distance along a media path in direction L. Carriage 44C is moved from right to left in direction K allowing a second set of nozzles of one or both of pens 42A and 42B to form overlays 88 and 90. As is apparent, the position of overlay 90 is incremented downward relative to the position of overlay 88. A single pen 42A or 42B may be used to form fields 84 and 86 and overlays 88 and 90. Alternatively, one pen 42A or 42B may be used to form fields 84 and 86 and the other pen 42B or 42A may be used to form overlays 88 and 90. While FIGS. 14 and 15 show fields 84, 86 and overlays 88, 92 being formed as carriage 44C is moved in opposing directions J and K, they could be formed as carriage 44C is moved in a single direction J or K.

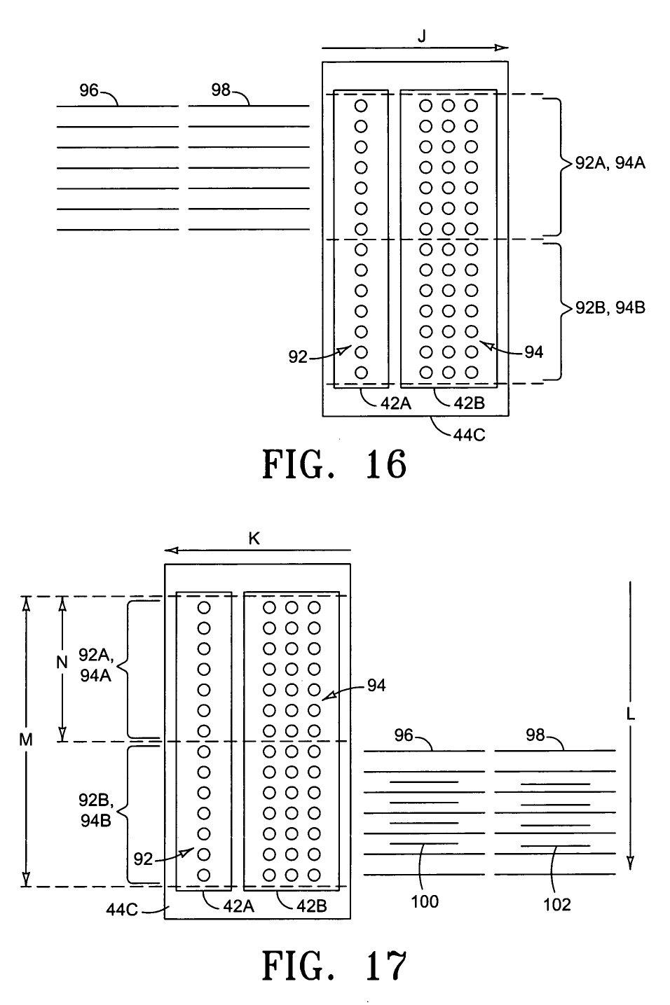

FIGS. 16-19 are schematic diagrams illustrating the selective use of nozzles of one or more pens 42A and 42B to print two or more sets of calibration patterns. In FIG. 16, pen 42A is shown to include two sets of nozzles 92A and 92B. Pen 42B is shown to include two sets of nozzles 94A and 94B. Carriage 44C is moved from left to right in direction J allowing one or both of nozzle sets 92A and 94A to form fields 96 and 98.

In FIG. 17, pens 42A and 42B are shown to have a height M for all nozzles and a half height N for nozzle sets 92A, 94A and 92B, 94B. As shown, the media sheet on which fields 96 and 98 were formed has been advanced a distance N along a media path in direction L. Carriage 44C is moved from right to left in direction K allowing one or both of nozzle sets 92B and 94B to form overlays 100 and 102. As shown, overlay 102 is incremented downward relative to the position of overlay 100. While FIGS. 16-19 show fields 96, 98,104, 106 and overlays 100, 102,108.110 being formed as carriage 44C is moved in opposing directions J and K, they could be formed as carriage 44C is moved in a single direction J or K.

In this example, nozzle sets 92A and 94A each represent one half of nozzle array for 92 or 94 located on the upstream side of pens 42A and 42B along media path L. Nozzle sets 92B and 94B each represent one half of nozzle array for 92 or 94 located on the downstream side of pens 42A and 42B along media path L.

In FIG. 18, the media sheet on which fields 96 and 98 and overlays 100 and 102 were formed has been advanced a distance along a media path in direction L. Carriage 44C is then moved from left to right in direction J allowing one or both of nozzle sets 92A and 94A to form fields 100 and 102.

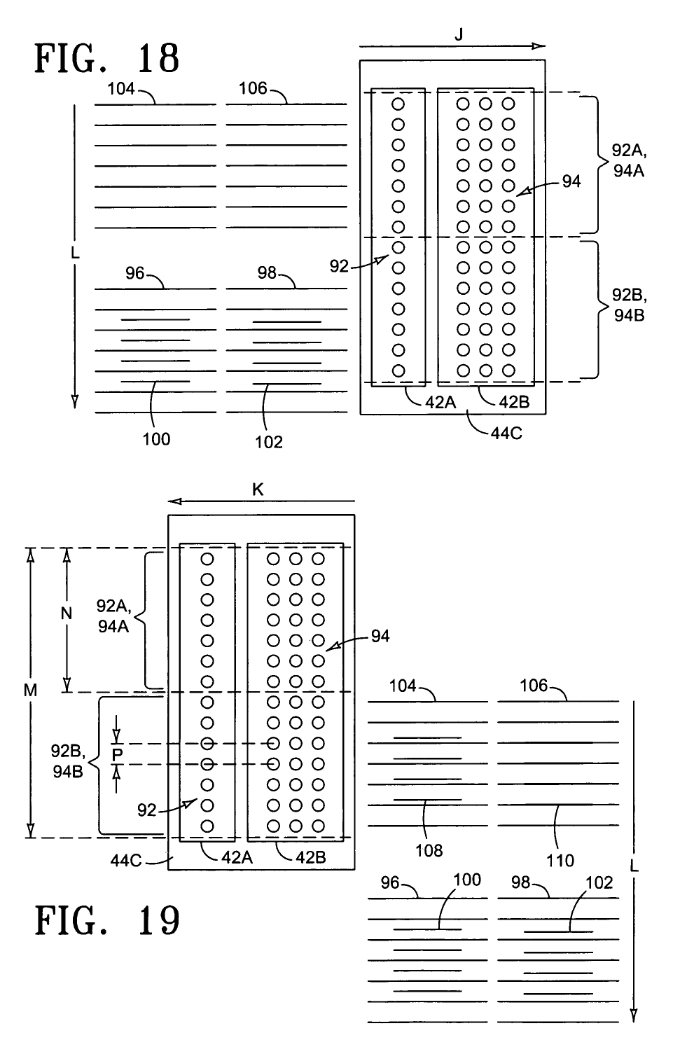

In FIG. 19, the distance between adjacent nozzles is P. The media sheet on which fields 104 and 106 were formed has been advanced a distance N plus or minus a fraction of P along a media path in direction L. As shown, the particular fraction is one-half of P. Carriage 44C is moved from right to left in direction K allowing one or both of nozzle sets 92B and 94B to form overlays 108 and 110. As is apparent, the position of overlay 110 is incremented downward relative to the position of overlay 108.

Where, for example, pens 42A and 42B have a six hundred dpi (dots per inch) resolution, the distance P is equal to 1/600^{th} of an inch. As a consequence, the distance between horizontal field lines or horizontal overlay lines of a particular calibration pattern is limited to step sizes of 1/600^{th} of an inch. Adjusting the distance the media sheet is advanced by a fraction of P increases the effective resolution. For example, where that fraction is one-half P, the effective resolution can be doubled from 600 dpi to 1200 dpi.

CONCLUSION: FIGS. 2-4 show examples of calibration pattern sets. However, implementation of the present invention is not limited to the particular geometry shown. A calibration pattern set can include any number of calibration patterns of any suitable size. The block and schematic diagrams of FIGS. 5-10 show the architecture, functionality, and operation of various embodiments of the present invention. A number of the blocks are defined, at least in part, as programs. Each of those blocks may represent in whole or in part a module, segment, or portion of code that comprises one or more executable instructions to implement the specified logical function(s). Each block may also represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagram of FIG. 11 shows a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

FIGS. 12-19 illustrate various exemplary methods for forming calibration patterns. Implementation of the present invention, however, is not limited to these methods.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A printer calibration method, comprising:
printing a first pattern having a first field and a first overlay formed within the first field;
printing a second pattern having a second field and a second overlay formed within the first field; and
updating a calibration parameter based on a selection of the first or second test pattern.

2. The method of claim 1, wherein:
printing the first pattern comprises printing a first field that includes a first series of evenly spaced lines and printing a first overlay that includes a second series of evenly spaced lines formed within the first field, the lines of the first field and the first overlay being substantially parallel to a first axis; and
printing the second pattern comprises printing a second field that includes a third series of lines and printing a second overlay that includes a fourth series of lines formed within the second field, the lines of the second field and the second overlay being substantially parallel to the first axis, the position of the third or fourth series of lines being incremented, relative to the first pattern, along a second axis substantially perpendicular to the first axis.

3. The method of claim 1, wherein printing the first and second patterns comprise using a first pen to form the first and second fields and using a second pen to form the first and second overlays.

4. The method of claim 1, wherein printing the first and second patterns comprises scanning one or more pens back and forth across an advancing media sheet wherein the first and second fields are formed as the one or more pens travel in a first scan direction and the first and second overlays are formed as the one or more pens travel in a second scan direction.

5. The method of claim 1, wherein printing the first and second patterns comprise using a first set of nozzles to form the first and second fields and using a second set of nozzles to form the first and second overlays.

6. The method of claim 1, further comprising:
scanning the first pattern to measure a first level of optical contrast between the first field and the first overlay;
scanning the second pattern to measure a second level of optical contrast between the second field and the second overlay
comparing the first level with the second level; and
selecting the first or second pattern based on the comparison.

7. A printer calibration method, comprising:
printing a set of patterns, wherein:
each pattern has a series of evenly spaced field lines and a series of evenly spaced overlay lines formed within the series of field lines, the field lines and the overlay lines being substantially parallel to a first axis;
for each successive pattern, a position of the series of field lines or the series of overlay lines is incremented, relative to a previous pattern, along a second axis that is substantially perpendicular to the first axis; and
updating a calibration parameter based on a selection of one of the patterns.

8. The method of claim 7, further comprising:
scanning each pattern to measure a level of optical contrast between the field lines and the overlay lines for that pattern;
comparing the measured levels; and
selecting one of the patterns based on the comparison.

9. The method of claim 7, wherein printing comprises using a pen having an array of nozzles to print the set of patterns on a media sheet advanced downstream along a media path past the pen, wherein, for each pattern, a first set of the nozzles is used to form the series of field lines and a second set of the nozzles is used to form the series of overlay lines.

10. The method of claim 9, wherein, relative to one another, the first set of nozzles are one half of the array of nozzles located upstream along the media path and the second set of nozzles are the remaining one half of the array of nozzles located downstream along the media path, the method further comprising advancing the media sheet downstream a distance equal to a height of the first set of nozzles after the first set of nozzles is used to form the series of field lines and before the second set of nozzles is used to form the overlay lines.

11. A printer calibration method, comprising:
printing a first set of patterns using a pen having an array of nozzles, the first set of patterns being formed on a media sheet advanced past the pen downstream along a media path, wherein:
each pattern has a field formed by a first set of the nozzles and an overlay formed within the field by a second set of the nozzles; and
relative to one another, the first set of nozzles are a first portion of the array of nozzles located upstream along the media path and the second set of nozzles are a second portion of the array of nozzles located downstream along the media path;
advancing the media sheet downstream a set distance equal to at least a height of the first set of nozzles after the first set of nozzles is used to form the fields of the first set of patterns and before the second set of nozzles is used to form the overlays of the first set of patterns;
printing a second set of patterns on the media sheet using the pen, wherein each of the second set of patterns has a field formed by the first set of the nozzles and an overlay formed within the field by the second set of the nozzles;
advancing the media sheet downstream the set distance plus or minus a fraction of a distance between two adjacent nozzles after the first set of nozzles is used to form the fields of the second set of patterns and before the second set of nozzles is used to form the overlays of the second set of patterns; and
updating a calibration parameter based on a selection of one of the patterns from the first or second sets of patterns.

12. The method of claim 11, further comprising:
for each pattern from the first and second sets of patterns, scanning that pattern to measure a level of optical contrast between the field and the overlay;
comparing the measured levels; and
selecting one of the patterns from the first or second sets of patterns based on the comparison.

13. The method of claim 11, wherein printing the first set and second sets of patterns comprises using the first set of nozzles to form fields that each include a series of evenly spaced field lines and using the second set of nozzles to form overlays that each include a series of evenly spaced overlay lines, the field lines and overlay lines being substantially parallel to a first axis; and
wherein, for each successive pattern in a set of patterns, a position of the series of field lines or the series of overlay lines is incremented, relative to a previous pattern in the set, along a second axis that is substantially perpendicular to the first axis.

14. A computer readable medium having instructions for:
printing a first pattern having a first field and a first overlay formed within the first field;
printing a second pattern having a second field and a second overlay formed within the first field; and
updating a calibration parameter based on a selection of the first or second test pattern.

15. The medium of claim 14, wherein the instructions for:
printing the first pattern include instructions for printing a first field that includes a first series of evenly spaced lines and printing a first overlay that includes a second series of evenly spaced lines formed within the first field, the lines of the first field and the first overlay being substantially parallel to a first axis; and
printing the second pattern include instructions for printing a second field that includes a third series of lines and printing a second overlay that includes a fourth series of lines formed within the second field, the lines of the second field and the second overlay being generally parallel to the first axis, the position of the third or fourth series of lines being incremented, relative to the first pattern, along a second axis substantially perpendicular to the first axis.

16. The medium of claim 14, wherein the instructions for printing the first and second patterns include instructions for using a first pen to form the first and second fields and using a second pen to form the first and second overlays.

17. The medium of claim 14, wherein the instructions for printing the first and second patterns include instructions for causing one or more pens to be scanned back and forth across an advancing media sheet wherein the first and second fields are formed as the one or more pens travel in a first scan direction and the first and second overlays are formed as the one or more pens travel in a second scan direction.

18. The medium of claim 14, wherein the instructions for printing the first and second patterns include instructions for using a first set of nozzles to form the first and second fields and using a second set of nozzles to form the first and second overlays.

19. The medium of claim 14, having further instructions for:
measuring, from a scan of the first pattern, a first level of optical contrast between the first field and the first overlay;
measuring, from a scan of the second pattern, a second level of optical contrast between the second field and the second overlay;
comparing the first level with the second level; and
selecting the first or second pattern based on the comparison.

20. A computer readable medium having computer executable instructions for:
printing a set of patterns, wherein:
each pattern has a series of evenly spaced field lines and a series of evenly spaced overlay lines formed within the series of field lines, the field lines and the overlay lines being substantially parallel to a first axis;
for each successive pattern, a position of the series of field lines or the series of overlay lines is incremented, relative to a previous pattern, along a second axis that is substantially perpendicular to the first axis; and
updating a calibration parameter based on a selection of one of the patterns.

21. The medium of claim 20, further comprising computer executable instructions for:
measuring, from a scan of each pattern, a level of optical contrast between the field lines and the overlay lines for that pattern;
comparing the measured levels; and
selecting one of the patterns based on the comparison.

22. The medium of claim 20, wherein the instructions for printing include instructions for using a pen having an array of nozzles to print the set of patterns on a media sheet advanced downstream along a media path past the pen, wherein, for each pattern, a first set of the nozzles is used to form the series of field lines and a second set of the nozzles is used to form the series of overlay lines.

23. The medium of claim 22, wherein, relative to one another, the first set of nozzles are one half of the array of nozzles located upstream along the media path and the second set of nozzles are the remaining one half of the array of nozzles located downstream along the media path, the medium having further instructions for causing the media sheet to be advanced downstream a distance equal to a height of the first set of nozzles after the first set of nozzles is used to form the series of field lines and before the second set of nozzles is used to form the overlay lines.

24. A computer readable medium having computer executable instructions for:
printing a first set of patterns using a pen having an array of nozzles, the first set of patterns being formed on a media sheet advanced past the pen downstream along a media path, wherein:
each pattern has a field formed by a first set of the nozzles and an overlay formed within the field by a second set of the nozzles; and
relative to one another, the first set of nozzles are a first portion of the array of nozzles located upstream along the media path and the second set of nozzles are a second portion of the array of nozzles located downstream along the media path;
causing the media sheet to be advanced downstream by a set distance equal to at least a height of the first set of nozzles after the first set of nozzles is used to form the fields of the first set of patterns and before the second set of nozzles is used to form the overlays of the first set of patterns;
printing a second set of patterns on the media sheet using the pen, wherein each of the second set of patterns has a field formed by the first set of the nozzles and an overlay formed within the field by the second set of the nozzles;
causing the media sheet to be advanced downstream by the set distance plus or minus a fraction of a distance between two adjacent nozzles after the first set of nozzles is used to form the fields of the second set of patterns and before the second set of nozzles is used to form the overlays of the second set of patterns; and
updating a calibration parameter based on a selection of one of the patterns from the first or second sets of patterns.

25. The medium of claim 24, having further instructions for:
for each pattern from the first and second sets of patterns, measuring, from a scan of that pattern, a level of optical contrast between the field and the overlay;
comparing the measured levels; and
selecting one of the patterns from the first or second sets of patterns based on the comparison.

26. The medium of claim 24, wherein the instructions for printing the first set and second sets of patterns include instructions for using the first set of nozzles to form fields that each include a series of evenly spaced field lines and using the second set of nozzles to form overlays that each include a series of evenly spaced overlay lines, the field lines and overlay lines being substantially parallel to a first axis; and
wherein, for each successive pattern in a set of patterns, a position of the series of field lines or the series of overlay lines is incremented, relative to a previous pattern in the set, along a second axis that is substantially perpendicular to the first axis.

27. A printer calibration system, comprising:
a pattern engine operable to print a first pattern having a first field and a first overlay formed within the first field and to print a second pattern having a second field and a second overlay formed within the first field; and
a calibrator operable to update a calibration parameter based on a selection of the first or second test pattern.

28. The system of claim 26, wherein the pattern engine is operable to:
print the first pattern by printing a first field that includes a first series of evenly spaced lines and printing a first overlay that includes a second series of evenly spaced lines formed within the first field, the lines of the first field and the first overlay being substantially parallel to a first axis; and
print the second pattern by printing a second field that includes a third series of lines and printing a second overlay that includes a fourth series of lines formed within the second field, the lines of the second field and the second overlay being generally parallel to the first axis, the position of the third or fourth series of lines being incremented, relative to the first pattern, along a second axis substantially perpendicular to the first axis.

29. The system of claim 27, wherein the pattern engine is operable to print the first and second patterns by causing a first pen to form the first and second fields and causing a second pen to form the first and second overlays.

30. The system of claim 27, wherein the pattern engine is operable to cause one or more pens to be scanned back and forth across an advancing media sheet wherein the first and second fields are formed as the one or more pens travel in a first scan direction and the first and second overlays are formed as the one or more pens travel in a second scan direction.

31. The system of claim 27, wherein the pattern engine is operable to printing the first and second patterns by causing a first set of nozzles to form the first and second fields and causing a second set of nozzles to form the first and second overlays.

32. The system of claim 27, further comprising a pattern selector operable to:
measure, from a scan of the first pattern, a first level of optical contrast between the first field and the first overlay;
measure, from a scan of the second pattern, a second level of optical contrast between the second field and the second overlay
compare the first level with the second level; and
select the first or second pattern based on the comparison.

33. A printer calibration system, comprising:
a pattern engine operable to print a set of patterns, wherein:
each pattern has a series of evenly spaced field lines and a series of evenly spaced overlay lines formed within the series of field lines, the field lines and the overlay lines being substantially parallel to a first axis; and
for each successive pattern, a position of the series of field lines or the series of overlay lines is incremented, relative to a previous pattern, along a second axis that is substantially perpendicular to the first axis; and
a calibrator operable to update a calibration parameter based on a selection of one of the patterns.

34. The system of claim 33, further comprising a pattern selector operable to:
measure, from a scan of each pattern, a level of optical contrast between the field lines and the overlay lines for that pattern;
compare the measured levels; and
select one of the patterns based on the comparison.

35. The system of claim 33, wherein the pattern engine is operable to print by causing a pen having an array of nozzles to print the set of patterns on a media sheet advanced downstream along a media path past the pen, wherein, for each pattern, a first set of the nozzles is used to form the series of field lines and a second set of the nozzles is used to form the series of overlay lines.

36. The system of claim 35, wherein, relative to one another, the first set of nozzles are one half of the array of nozzles located upstream along the media path and the second set of nozzles are the remaining one half of the array of nozzles located downstream along the media path, wherein the pattern engine is operable to cause the media sheet to be advanced downstream a distance equal to a height of the first set of nozzles after the first set of nozzles is used to form the series of field lines and before the second set of nozzles is used to form the overlay lines.

37. A printer calibration system, comprising:
a pattern engine operable to:
use a pen having an array of nozzles to print a first set of patterns and a second set of patterns on a media sheet advanced past the pen downstream along a media path, wherein each pattern has a field formed by a first set of the nozzles and an overlay formed within the field by a second set of the nozzles where, relative to one another, the first set of nozzles are a first portion of the array of nozzles located upstream along the media path and the second set of nozzles are a second portion of the array of nozzles located downstream along the media path;
cause the media sheet to be advanced downstream a set distance equal to at least a height of the first set of nozzles after the first set of nozzles is used to form the fields of the first set of patterns and before the second set of nozzles is used to form the overlays of the first set of patterns;
cause the media sheet to be advanced downstream a the set distance plus or minus a fraction of a distance between two adjacent nozzles after the first set of nozzles is used to form the fields of the second set of patterns and before the second set of nozzles is used to form the overlays of the second set of patterns; and
a calibrator operable to update a calibration parameter based on a selection of one of the patterns from the first or second sets of patterns.

38. The system of claim 37, further comprising a pattern selector operable to:
for each pattern from the first and second sets of patterns, measure, from a scan of that pattern, a level of optical contrast between the field and the overlay;
compare the measured levels; and
select one of the patterns from the first or second sets of patterns based on the comparison.

39. The system of claim 37, wherein the pattern engine is operable to print the first set and second sets of patterns by using the first set of nozzles to form fields that each include a series of evenly spaced field lines and using the second set of nozzles to form overlays that each include a series of evenly spaced overlay lines, the field lines and overlay lines being substantially parallel to a first axis; and
wherein, for each successive pattern in a set of patterns, a position of the series of field lines or the series of overlay lines is incremented, relative to a previous pattern in the set, along a second axis that is substantially perpendicular to the first axis.

40. A printer calibration system, comprising:
a means for printing a first pattern having a first field and a first overlay formed within the first field;
a means for printing a second pattern having a second field and a second overlay formed within the first field; and
a means for updating a calibration parameter based on a selection of the first or second test pattern.
